(19) United States
(12) Patent Application Publication
(10) Pub. No.: US 2012/0054606 A1
(43) Pub. Date: Mar. 1, 2012

(54) DOCUMENT DISPLAY METHOD AND DOCUMENT DISPLAY DEVICE

(75) Inventor: Hajime TERAYOKO, Tokyo (JP)

(73) Assignee: FUJIFILM CORPORATION, Tokyo (JP)

(21) Appl. No.: 13/216,175

(22) Filed: Aug. 23, 2011

(30) Foreign Application Priority Data
Aug. 27, 2010 (JP) JP 2010-190928

(51) Int. Cl. G06F 3/14

(52) U.S. Cl. 715/273

(57) ABSTRACT

A document display method for causing a document including a plurality of lines and a plurality of characters to be scrolled in a line writing direction and to be displayed in a predetermined display screen that allows the plurality of lines and the plurality of characters included in the document to be displayed at the same time, the document display method comprising:

consecutively connecting an end of a line in text including a plurality of lines and a beginning of a line in the text including the plurality of lines in the predetermined display screen, and performing an automatic scroll operation on the text including the plurality of lines endlessly; and

causing the end of a line in the text including the plurality of lines and the beginning of a line in the text including the plurality of lines to be displayed so as to be consecutively connected by shifting upward and downward by one line at a time.

### BACKGROUND OF THE INVENTION

1. Field of the Invention

The present invention relates to a document display method and a document display device, and more specifically, to a technique for displaying text through scrolling.

2. Description of the Related Art

Conventionally, a display device is well known to display characters by scrolling the characters when one line of text including a plurality of characters is displayed and the line contains more characters than are allowed to be displayed on a display unit.

On the other hand, Japanese Patent Application Laid-Open No. 07-6177 proposes a portable electronic reading device that displays text including a plurality of lines by scrolling the lines to make it easy to understand the text while reading in comparison with the technique for displaying text including only one line by scrolling a display screen. The portable electronic reading device displays character strings continuing between each of the lines on a display unit that is able to display a plurality of lines as well as displays the text by scrolling the display screen so that the character strings in each of the lines are continuously moved.

In addition, Japanese Patent Application Laid-Open No. 2005-92567 proposes a scroll control device that displays a document image by scrolling a display screen in only one direction in order to solve the problem that it is not easy to two-dimensionally manipulate a scroll horizontally and vertically when a large document image is partially displayed on a limited screen space, for example, a screen of a personal digital assistant (PDA).

The invention described in Japanese Patent Application Laid-Open No. 2005-92567 proposes a technique for displaying a beginning of a next line and then causing a display screen to jump to a location that is shifted downward by one line when the end of a line is included in the display screen and then an instruction is made for displaying a next character in a case where a larger document image than a screen size of a display device is displayed, thereby enabling scrolling in only one direction (claim 6 of Japanese Patent Application Laid-Open No. 2005-92567).

In the invention discussed in Japanese Patent Application Laid-Open No. 07-6177, a line break is performed depending on the number of characters that can be displayed on the display unit when a long text is displayed across a plurality of lines. In addition, an original large document image is not edited and a part of the document image is not clipped. Furthermore, when images, figures, etc. in addition to characters are included in the original document, it is difficult to display the images, figures, etc. by scrolling them.

In the invention described in Japanese Patent Application Laid-Open No. 2005-92567, images, figures, etc. in addition to characters can be displayed because a part of a large document image is displayed by scrolling. However, when the display screen reaches the rear end of the document image by scrolling in only one direction (that is, the end of a line is included in the display screen) and then an instruction is made for displaying a next character, the display screen returns to the beginning of the document image, a beginning of a next line is displayed and the display screen is caused to jump to a location that is shifted downward by one line. As a result, there exists a problem in that a position of the viewpoint is needed to be moved from the end of a line to the beginning of a line while reading the text. In addition, it is difficult to keep a constant scroll speed because there is discontinuous screen transition, thereby being unsuitable for an automatic scroll operation.

### SUMMARY OF THE INVENTION

The present invention has been developed in view of such circumstances. An object of the present invention is to provide a document display method and a document display device for allowing a document to be read while a position of a viewpoint is fixed without changing a layout of an original document such as an electronic book.

To attain the foregoing object, a document display method according to a first aspect of the present invention for causing a document including a plurality of lines and a plurality of characters to be scrolled in a line writing direction and to be displayed in a predetermined display screen that allows the plurality of lines and the plurality of characters included in the document to be displayed at the same time, and includes:

consecutively connecting an end of a line in text including a plurality of lines and a beginning of a line in the text including the plurality of lines in the predetermined display screen and performing an automatic scroll operation on the text including the plurality of lines endlessly; and

causing the end of a line in the text including the plurality of lines and the beginning of a line in the text including the plurality of lines to be displayed so as to be consecutively connected by shifting upward and downward by one line at a time.

As a result, a long text can be read while a position of a viewpoint is fixed without changing a layout of an original document. The document display method makes it easy to read the text in comparison with the technique for displaying text including only one line by scrolling a display screen, and can be also applied to a document including an image and a figure, etc.

According to a second aspect of the present invention, in the document display method described in the first aspect, characters in a center of the display screen are displayed so as to be accentuated. As a result, a point of gaze becomes settled, and thus a viewpoint can be fixed.

According to a third aspect of the present invention, in the document display method described in the second aspect, the characters in the center of the display screen are displayed brightly in comparison with characters in a peripheral area.

According to a fourth aspect of the present invention, in the document display method described in the second aspect, the characters in the center of the display screen are displayed so as to be magnified in comparison with characters in the peripheral area.

According to a fifth aspect of the present invention, in the document display method described in any one of aspects from the first aspect to the fourth aspect, when a blank area that does not include characters up to the end of a line due to a line break comes to the center of the display screen, a speed of the automatic scroll operation is raised, or the blank area is skipped and then the display screen is moved so that a character at a beginning of a line comes to the center of the display screen.

According to a sixth aspect of the present invention, in the document display method described in any one of aspects from the first aspect to the fifth aspect, the text on which the automatic scroll operation is performed is text clipped from an original document.

According to a seventh aspect of the present invention, in the document display method described in the sixth aspect, the original document is data including only text data, data including only image data, or data including a mixture of image data and text data.

According to a eighth aspect of the present invention, in the document display method described in any one of aspects from the first aspect to the seventh aspect, a boundary between the end of a line in the text including a plurality of lines and the beginning of a line in the text including a plurality of lines, and a boundary between pages are displayed so as to allow the boundaries to be visually identified. As a result, it is easy to understand a correspondence of characters between an end of a line and a beginning of a next line, or a correspondence between pages, and in addition, it is possible to grasp which location in a page is read.

A document display device according to a ninth aspect of the present invention includes:

an information input device which obtains an original document including one or more pages;

a display device which includes a predetermined display screen that allows a plurality of lines and a plurality of characters included in a document to be displayed at the same time, the plurality of lines and the plurality of characters being clipped from the original document; and

a display control device which causes a part of the original document to be displayed in the display screen by performing an automatic scroll operation on text including the plurality of lines in a line writing direction in the predetermined display screen; wherein

the display control device consecutively connects an end of a line in the text including the plurality of lines and a beginning of a line in the text including the plurality of lines in the predetermined display screen and performs the automatic scroll operation on the text including the plurality of lines endlessly while the end of a line in the text including the plurality of lines and the beginning of a line in the text including the plurality of lines are displayed so as to be consecutively connected by shifting upward and downward by one line at a time.

According to a tenth aspect of the present invention, in the document display device described in the ninth aspect, the display control device displays so as to accentuate characters in a center of the display screen.

According to a eleventh aspect of the present invention, in the document display device described in the ninth aspect, the display control device displays the characters in the center of the display screen brightly in comparison with characters in a peripheral area.

According to a twelfth aspect of the present invention, in the document display device described in the ninth aspect, the display control device displays so as to magnify the characters in the center of the display screen in comparison with characters in the peripheral area.

According to a thirteenth aspect of the present invention, in the document display device described in any one of aspects from the ninth aspect to the twelfth aspect, when a blank area that does not include characters up to the end of a line due to a line break comes to the center of the display screen, the display control device raises a speed of the automatic scroll operation, or the display control device skips the blank area and then moves the display screen so that a character at a beginning of a line comes to the center of the display screen.

According to a fourteenth aspect of the present invention, in the document display device described in any one of aspects from the ninth aspect to the thirteenth aspect, the original document is data including only text data, data including only image data, or data including a mixture of image data and text data.

According to a fifteenth aspect of the present invention, in the document display device described in any one of aspects from the ninth aspect to the fourteenth aspect, the display control device displays so as to allow a boundary between the end of a line in the text including a plurality of lines and the beginning of a line in the text including a plurality of lines, and a boundary between pages to be visually identified.

A sixteenth aspect of the present invention is a programmable storage medium tangibly embodying a program of machine-readable instructions executable by a digital processing apparatus to perform a document display method, said method comprising:

an information input step to obtain an original document including one or more pages; and

a display control step to cause a document including a plurality of lines and a plurality of characters clipped from the original document to be displayed in a display device including a predetermined display screen that allows a plurality of lines and a plurality of characters included in the document to be displayed at the same time, the display control step causing a part of the original document to be displayed in the display screen by performing an automatic scroll operation on text including a plurality of lines in a line writing direction in the predetermined display screen, wherein

the display control step consecutively connects an end of a line in the text including a plurality of lines and a beginning of a line in the text including the plurality of lines in the predetermined display screen, and performs the automatic scroll operation on the text including the plurality of lines endlessly while the end of a line in the text including the plurality of lines and the beginning of a line in the text including the plurality of lines are displayed so as to be consecutively connected by shifting upward and downward by one line at a time.

According to the present invention, an end of a line in the text including the plurality of lines and a beginning of a line in the text including the plurality of lines in the predetermined display screen are consecutively connected and then the automatic scroll operation is performed on the text including the plurality of lines endlessly while the end of a line in the text including the plurality of lines and the beginning of a line in the text including the plurality of lines are displayed so as to be consecutively connected by bringing the text up and down by one line at a time, and thereby it is possible to read a document while a layout of original documents including an electronic book is not changed and then a location of the viewpoint is fixed.

### BRIEF DESCRIPTION OF THE DRAWINGS

FIG. 1 is a block diagram illustrating an embodiment of a document display device according to the present invention;

FIG. 2 is a conceptual view illustrating a document display method according to the present invention;

FIG. 3 is a conceptual plan view illustrating the document display method according to the present invention;

FIG. 4 is a flowchart illustrating document display operations in the document display device;

FIG. 5 is a diagram illustrating an embodiment of a display screen in a display unit;

FIG. 6 is a diagram illustrating another embodiment of the display screen in the display unit;

FIG. 7 is a diagram illustrating the display method when text includes a line break point; and

FIG. 8 is a diagram illustrating a document display system including the document display device.

### DETAILED DESCRIPTION OF THE PREFERRED EMBODIMENTS

Hereinafter, embodiments of a document display method and device according to the present invention will be described with reference to the accompanying drawings.

<A Configuration of the Document Display Device>

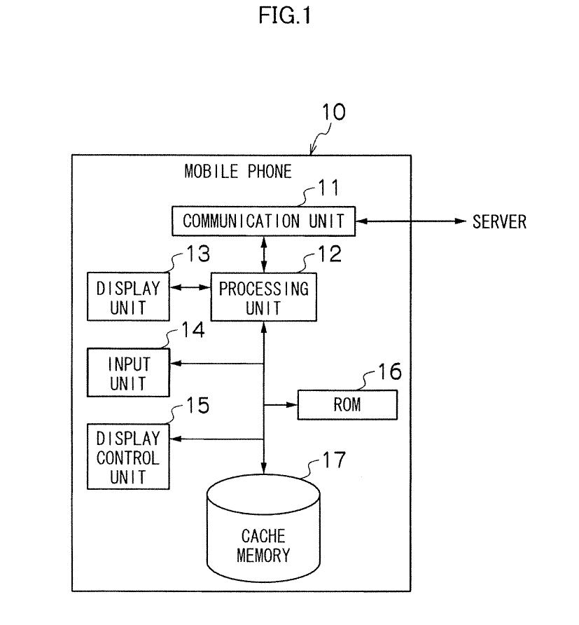

FIG. 1 is a block diagram illustrating an embodiment of the document display device according to the present invention and illustrates a mobile phone 10 in the embodiment.

As illustrated in FIG. 1, the mobile phone 10 is mainly configured by a communication unit 11, a processing unit 12, a display unit 13, an input unit 14, a display control unit 15, a read-only memory (ROM) 16 and a cache memory 17. Note that a microphone, a speaker, etc. are also included in the mobile phone 10 in order to function as an ordinary mobile phone, but are omitted in FIG. 1. The communication unit 11 communicates with other mobile phones and servers on the Internet by performing radio communication through a base station.

The processing unit 12 is a unit to perform overall control of the whole mobile phone 10 in accordance with a predetermined control program based on an operation signal input from the input unit 14, and a CPU, etc. may be employed for the processing unit 12.

The display unit 13 is configured by a color liquid crystal display device and is used as a display device to display document information (document images) including characters, images, figures, etc. in addition to as a user interface when various setting operations are performed.

The input unit 14 is configured by a numeric keypad, a multifunction cross key, an execution key, a cancel key, or a touch-screen, etc.

The display control unit 15 is a unit to generate display information displayed in the display unit 13. The display control unit 15 is described in detail later.

In the ROM 16, a control program by which the mobile phone 10 is operated, the document display program according to the embodiment, etc. are stored, and the processing unit 12 and the display control unit 15 performs a required arithmetic operation in accordance with the control program or the document display program. Note that the ROM 16 is configured, for example, by a flash ROM.

The cache memory 17 is used as an arithmetic operation area in which the processing unit 12 or the display control unit 15 performs a required arithmetic operation and used as a temporary storage area for document information to be displayed in the display unit 13 of the mobile phone 10, and configured, for example, by a volatile memory.

<Summary of the Document Display>

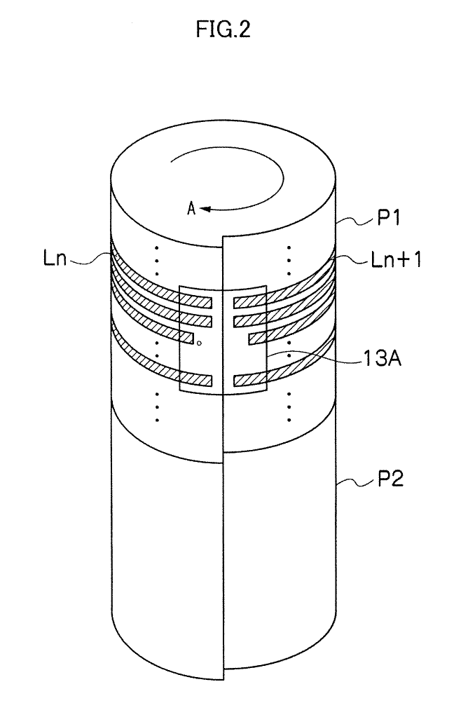

FIG. 2 is a conceptual view illustrating the document display method according to the present invention.

As illustrated in FIG. 2, documents P1 and P2 each of which has a one-page portion and that are each cylindrically curved are connected one above the other, and are rotated in “a” direction illustrated by an arrow A in FIG. 2 at a constant speed. Areas illustrated by hatching in FIG. 2 indicate areas of character strings, and the documents P1 and P2 are documents with horizontal writing. In addition, an end of a line and a beginning of a line in each of the document's P1 and P2 are consecutively connected by shifting upward and downward by one line at a time. That is, an end of a line Ln included in the document P1 is adapted to be consecutively connected to a beginning of a next line Ln+1.

In FIG. 2, a frame line 13A indicates a display screen of the display unit 13 in the mobile phone 10. When the documents P1 and P2 that are cylindrically curved are rotated at a constant speed, the documents P1 and P2 can be displayed so as to be moved in a line writing direction (scrolled horizontally).

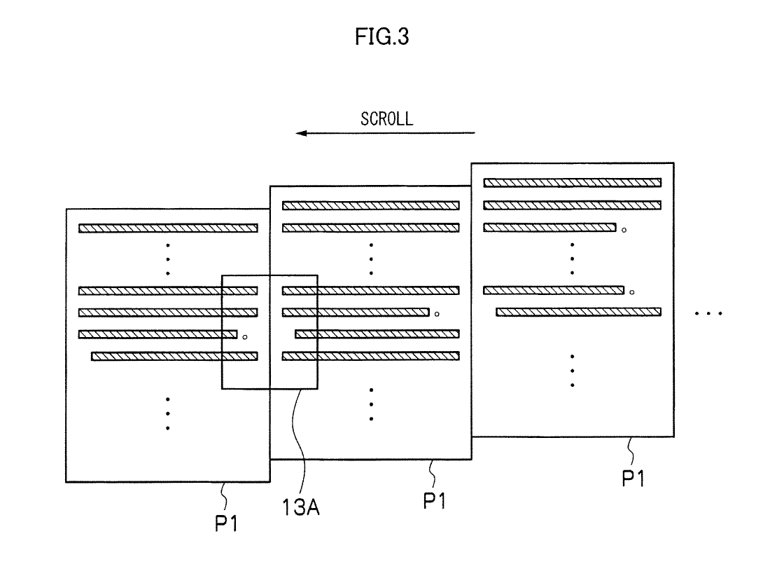

FIG. 3 is a conceptual plan view illustrating the above-described document display method. As can also seen from FIG. 3, a document that includes a plurality of lines and is displayed on the display screen of the display unit 13 is shifted by one line each time a scroll operation for a one-line portion is performed on the document.

Thus, when an automatic scroll operation is performed on the document endlessly, the whole document can be continued to be read and a position of viewpoint can be fixed.

### An Embodiment of the Document Display Method

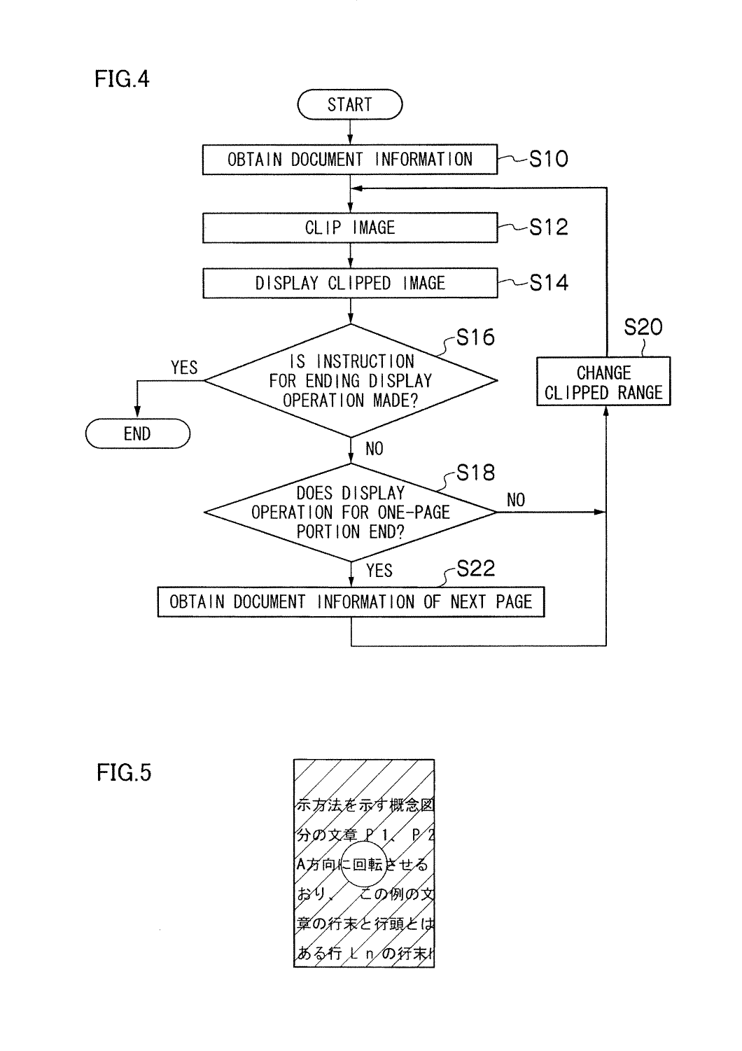

Next, document display operations performed in the mobile phone 10 illustrated in FIG. 1 (document display device) are described with reference to a flowchart illustrated in FIG. 4.

Previously, a user accesses a server providing electronic books by the mobile phone 10, downloads a desired electronic book, and causes the flash ROM 16 to store the downloaded electronic book. In the embodiment, an electronic book includes a document image in which one page is configured by one image in a bitmap format, etc.

Next, when the user activates a document display program for reading the electronic book stored in the flash ROM 16, a document display operation starts.

In FIG. 4, first, the display control unit 15 reads document information (document images) including an initial two-page portion of the electronic book stored in the flash ROM 16, and causes the cache memory 17 to store the document information temporarily (step S10). Here, the document images including a two-page portion are obtained in order to allow the document image that extends over two pages to be displayed.

Note that the display control unit 15 obtains information such as the number of lines and line spacing included in one page of the read document image. The information such as the number of lines and the line spacing can be obtained by reading document images using an Optical Character Reader (OCR) function. In addition, when the information such as the number of lines and line spacing is added as additional information of the electronic books, the information such as the number of lines and the line spacing can be obtained from the additional information.

Next, the display control unit 15 clips an area (the area within the frame line 13A illustrated in FIGS. 2 and 3) corresponding to the display screen of the display unit 13, from the document images temporarily stored in the cache memory 17 (step S12). Here, the area to be clipped is determined based on a screen size of the display unit 13 and a size of characters to be displayed. A size of characters set as default may be used to be displayed, or a size of characters set as appropriate by a user may be used to be displayed. In addition, an initial clipped area is determined so that a beginning of a first line in a first page is located at a center of the display unit 13.

The display control unit 15 causes the document image clipped in such a way as described above to be displayed on the display unit 13 (step S14).

After that, the display control unit 15 determines whether or not an instruction for ending a display operation for the document is made (step S16), and when an instruction for ending a display operation for the document is made (“Yes” in step S16), the document display processing ends. At that time, the display control unit 15 causes the flash ROM 16 to store information indicating a page in which the electronic book has been finished to be displayed or a line of page in which the electronic book has been finished to be displayed, thereby enabling display of a location continued from the last time when the same electronic book is read the next time.

When an instruction for ending a display operation for the document is not made (“No” in step S16), the display control unit 15 determines whether or not a display operation of a document image for a one-page portion ends (step S18). When a display operation of a document image for a one-page portion does not end (“No” in step S18), the processing proceeds to step S20. When a display operation of a document image for a one-page portion ends (“Yes” in step S18), the processing proceeds to step S20 after the processing proceeds to step S22.

In step S20, the range clipped from the document image is changed. That is, the clipped range indicated by the frame line 13A as illustrated in FIG. 3 is moved by one dot in a right direction on FIG. 3. In addition, when the clipped range extends across an end of a line to a beginning of a line in the document image as described above, the clipped range of the side of the beginning of a line corresponds to an range shifted upward and downward by one line spacing.

When the clipped range is changed as described above, the processing returns to step S12 and the document image in the changed clipped range is clipped.

After that, the document image in which the clipped range is changed by one dot at a time is displayed by repeating the processing from step S12 to step S20, thereby moving (scrolling) the document image by one dot at a time.

A scroll speed may be set based on the processing time in step S12 to step S20. For example, when the number of characters read per unit time is set, a scroll speed may be set based on an interval of one dot on the display screen of the display unit 13 and an interval between characters on the displayed document image (the number of dots between characters). A scroll speed set for each type of mobile phone 10 as default may be used, or a scroll speed set in the input unit 14 may be used.

On the other hand, in step S22, when a display operation of a document image for a one-page portion ends, a document image in a next page is obtained. That is, when a display operation of a document image for a one-page portion ends, the document image in the page is deleted from the cache memory 17 and a document image in a page next to the page currently being displayed is read from the flash ROM 16 and written into the cache memory 17.

>Another Embodiment of the Document Display Operation>

Next, an embodiment of the document display operation for displaying on the display unit 13 of the mobile phone 10 is described.

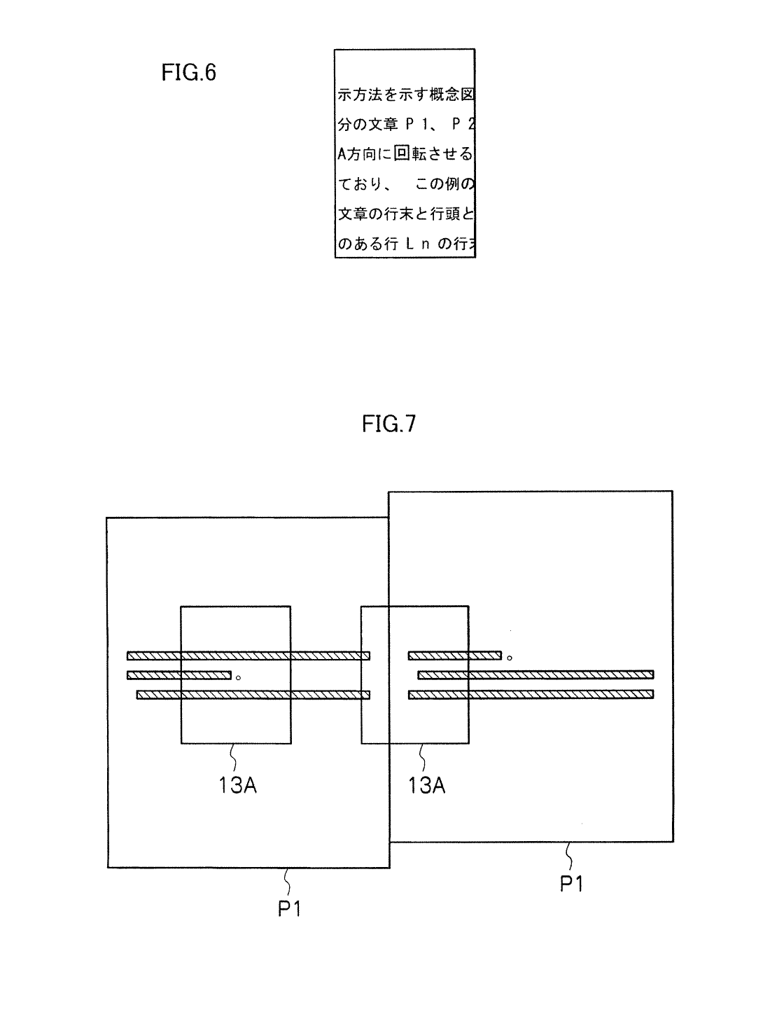

FIGS. 5 and 6 are diagrams each illustrating an embodiment of the display screen of the display unit 13. As illustrated in such drawings, characters at a center of the display screen of the display unit 13 are displayed so as to be accentuated.

That is, in the example illustrated in FIG. 5, brightness is varied between a center of the display screen and a peripheral area of the center of the display screen, and the center of the display screen is displayed so that a spotlight is casted on the center of the display screen. As a result, a viewpoint of a user is adapted to be directed to the center of the display screen.

In addition, in the example illustrated in FIG. 6, characters in a center of the display screen are displayed so as to be magnified in comparison with characters in a peripheral area of the center of the display screen. Note that, although only one character is magnified in the example illustrated in FIG. 6, alternatively, a plurality of characters or one whole line at a center of the display screen also may be magnified. As a result, a viewpoint a user is adapted to be directed to the center of the display screen, and a position of the viewpoint can be fixed.

FIG. 7 is a diagram illustrating the document display method when text includes a line break point.

When text includes a line break point as illustrated in FIG. 7, and the line break point reaches the center of the display screen, there is a blank area that ranges from the line break point to an end of a line. In this case, a speed of the automatic scroll operation is raised in the blank area, and the blank area is scrolled so as to be skipped.

A clipped range illustrated by the frame line 13A at a left side of FIG. 7 indicates a clipped range when a line break point comes to the center of the display screen, and a clipped range illustrated by the frame line 13A at a right side of FIG. 7 indicates a clipped range when a beginning of a line next to a line including a line break point reaches the center of the display screen. In this case, during a time period when a scroll operation is performed from the clipped range illustrated by the frame line 13A at a left side of FIG. 7 to the clipped range illustrated by the frame line 13A at a right side of FIG. 7, the scroll operation is performed so that an automatic scroll speed is raised or a character at the beginning of a line comes to the center of the display screen after such a time period (blank area) is skipped.

<A Document Display System Including the Document Display Device>

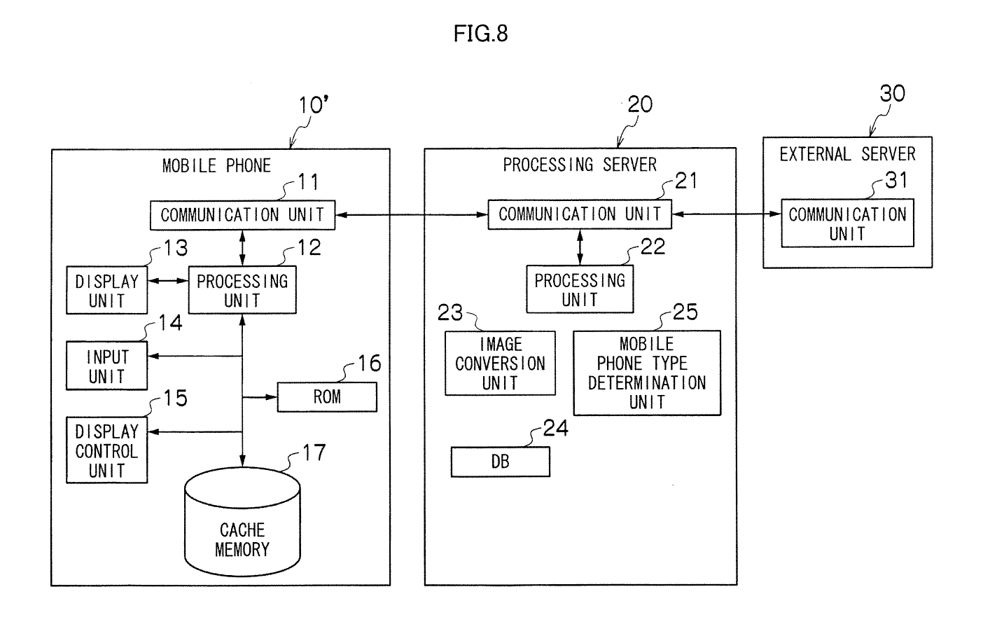

FIG. 8 is a diagram illustrating a document display system including a mobile phone 10′ (document display device). Note that units similar to those illustrated in FIG. 1 are assigned the same reference numerals, and the detailed description thereof is omitted.

The document display system illustrated in FIG. 8 is mainly configured by the mobile phone 10′, a processing server 20, and an external server (electronic book website) 30. In addition, the mobile phone 10 and the processing server 20 can communicate with each other through a base station (not illustrated), a mobile phone network, a wireless carrier, and the Internet.

The mobile phone 10′ includes components substantially similar to the components of the mobile phone 10 illustrated in FIG. 1, and the detailed description thereof is omitted here.

The processing server 20 is a relay server which allows an electronic book website to be browsed on the mobile phone 10 and is mainly configured by a communication unit 21, a processing unit 22, an image conversion unit 23, a database (DB) 24, and a mobile phone type determination unit 25, etc.

The communication unit 21 is a device which performs communication such as transmission and reception of information, with the communication unit 11 in the mobile phone 10 and a communication unit 31 in the external server 30.

The processing unit 22 is a unit which causes a program for information distribution, etc. that runs on a server to run, and a CPU, etc. performing overall control of the whole server 20 may be employed for the processing unit 22.

The image conversion unit 23 is a unit which converts contents that are in various formats, that include an electronic book, and that are obtained from the external server 30 through the communication unit 21 in response to a browse request of an electronic book from the mobile phone 10, to an image available for browsing with various mobile phones (for example, images in a bitmap format).

The DB 24 records and manages a status of browsing for an electronic book browsed by a user and a status of usage for electronic books that have been browsed in the past.

The mobile phone type determination unit 25 is a unit which determines a type of a mobile phone utilizing the document display system based on information received from the communicating mobile phone, and information of the determined type of the mobile phone is used for conducting a service depending on functions of the mobile phone (for example, a size of a display screen, a transmission speed, a capacity of a cache memory, etc).

The mobile phone 10 illustrated in FIG. 1 downloads an electronic book from an external server, etc., and causes the flash ROM 16 to store the downloaded electronic book. However, the mobile phone 10′ of the system is different from the mobile phone 10 in that the mobile phone 10′ mainly receives a minimum document image required for a display operation to the display screen from the processing server 20 each time a clipped range of the document image is changed.

That is, in the processing for obtaining document information in step S10 illustrated in FIG. 4, when a request for browsing a desired electronic book is requested to the processing server 20, a document image including an initial two-page portion of the electronic book imaged in the processing server 20 is obtained and the obtained document image is stored temporarily in the cache memory 17. In the processing for obtaining document information of a next page in step S22 illustrated in FIG. 4, a request for obtaining a document image in a next page from the mobile phone 10′ is requested at a timing at which a display operation for a one-page portion ends, and the document image in the requested page is obtained from the processing server 20 and stored in the cache memory 17.

The other processing including the above-described document display method is performed in a way similar to the mobile phone 10. In the system, it is possible that information of an electronic book can be adapted not to remain in the mobile phone 10′ after browsing.

### Other Embodiments

In the embodiment, although a boundary between an end of a line and a beginning of a line, and a boundary between pages can be visually identified due to the corresponding blank area because a part of an electronic book is clipped and displayed as-is, alternatively, a boundary line may be caused to be displayed on each of the boundaries. In addition, a page number currently being displayed, a line number of a line located at a center of the display screen may be caused to be displayed on a corner of the display unit. As a result, it is easy to understand which part of an electronic book is displayed.

In addition, an electronic book in which an original document is imaged is described in the embodiment, but a target to be displayed is not limited to electronic books in the present invention, and various types of documents can be displayed. Furthermore, an original document is not limited to image data, and the present invention can be applied to data including only text data and data including a mixture of text data, and images or figures.

The document display device according to the present invention can be applied not only to a mobile phone but also to other terminals such as a smart phone, a personal handyphone system (PHS), and PDA.

In addition, the present invention can be applied not only to an original document with horizontal writing but also to an original document with vertical writing. In the case of an original document with vertical writing, the document is caused to be scrolled vertically.

In addition, the present invention is not limited to the above-described embodiments, and it goes without saying that various modifications can be made to the embodiments without departing from the spirit of the present invention.

What is claimed is:

1. A document display method for causing a document including a plurality of lines and a plurality of characters to be scrolled in a line writing direction and to be displayed in a predetermined display screen that allows the plurality of lines and the plurality of characters included in the document to be displayed at the same time, the document display method comprising:
consecutively connecting an end of a line in text including a plurality of lines and a beginning of a line in the text including the plurality of lines in the predetermined display screen, and performing an automatic scroll operation on the text including the plurality of lines endlessly; and
causing the end of a line in the text including the plurality of lines and the beginning of a line in the text including the plurality of lines to be displayed so as to be consecutively connected by shifting upward and downward by one line at a time.

2. The document display method according to claim 1, wherein
characters in a center of the display screen are displayed so as to be accentuated.

3. The document display method according to claim 2, wherein
the characters in the center of the display screen are displayed brightly in comparison with characters in a peripheral area.

4. The document display method according to claim 2, wherein
the characters in the center of the display screen are displayed so as to be magnified in comparison with characters in the peripheral area.

5. The document display method according to claim 1, wherein
when a blank area that does not include characters up to the end of a line due to a line break comes to the center of the display screen, a speed of the automatic scroll operation is raised, or the blank area is skipped and then the display screen is moved so that a character at a beginning of a line comes to the center of the display screen.

6. The document display method according to claim 1, wherein
the text on which the automatic scroll operation is performed is text clipped from an original document.

7. The document display method according to claim 6, wherein
the original document is data including only text data, data including only image data, or data including a mixture of image data and text data.

8. The document display method according to claim 1, wherein
a boundary between the end of a line in the text including a plurality of lines and the beginning of a line in the text including a plurality of lines, and a boundary between pages are displayed so as to allow the boundaries to be visually identified.

9. A document display device comprising:
an information input device which obtains an original document including one or more pages;
a display device which includes a predetermined display screen that allows a plurality of lines and a plurality of characters included in a document to be displayed at the same time, the plurality of lines and the plurality of characters being clipped from the original document; and
a display control device which causes a part of the original document to be displayed in the display screen by performing an automatic scroll operation on text including the plurality of lines in a line writing direction in the predetermined display screen, wherein
the display control device consecutively connects an end of a line in the text including a plurality of lines and a beginning of a line in the text including the plurality of lines in the predetermined display screen, and performs the automatic scroll operation on the text including the plurality of lines endlessly while the end of a line in the text including the plurality of lines and the beginning of a line in the text including the plurality of lines are displayed so as to be consecutively connected by shifting upward and downward by one line at a time.

10. The document display device according to claim 9, wherein
the display control device displays so as to accentuate characters in a center of the display screen.

11. The document display device according to claim 9, wherein
the display control device displays the characters in the center of the display screen brightly in comparison with characters in a peripheral area.

12. The document display device according to claim 9, wherein
the display control device displays so as to magnify the characters in the center of the display screen in comparison with characters in the peripheral area.

13. The document display device according to claim 9, wherein
when a blank area that does not include characters up to the end of a line due to a line break comes to the center of the display screen, the display control device raises a speed of the automatic scroll operation, or the display control device skips the blank area and then moves the display screen so that a character at a beginning of a line comes to the center of the display screen.

14. The document display device according to claim 9, wherein
the original document is data including only text data, data including only image data, or data including a mixture of image data and text data.

15. The document display device according to claim 9, wherein
the display control device displays so as to allow a boundary between the end of a line in the text including a plurality of lines and the beginning of a line in the text including a plurality of lines, and a boundary between pages to be visually identified.

16. A programmable storage medium tangibly embodying a program of machine-readable instructions executable by a digital processing apparatus to perform a document display method, said method comprising:
an information input step to obtain an original document including one or more pages; and
a display control step to cause a document including a plurality of lines and a plurality of characters clipped from the original document to be displayed in a display device including a predetermined display screen that allows a plurality of lines and a plurality of characters included in the document to be displayed at the same time, the display control step causing a part of the original document to be displayed in the display screen by performing an automatic scroll operation on text including a plurality of lines in a line writing direction in the predetermined display screen, wherein
the display control step consecutively connects an end of a line in the text including a plurality of lines and a beginning of a line in the text including the plurality of lines in the predetermined display screen, and performs the automatic scroll operation on the text including the plurality of lines endlessly while the end of a line in the text including the plurality of lines and the beginning of a line in the text including the plurality of lines are displayed so as to be consecutively connected by shifting upward and downward by one line at a time.
